(19) United States
(12) Patent Application Publication
(10) Pub. No.: US 2011/0258047 A1
(43) Pub. Date: Oct. 20, 2011

(54) INCORPORATING TIME AND SPATIAL RELATIONSHIPS BETWEEN USER/ADVERTISER LOCATIONS INTO ADVERTISEMENT RELEVANCE

(75) Inventor: John Carey, Sammamish, WA (US)

(73) Assignee: MICROSOFT CORPORATION, Redmond, WA (US)

(21) Appl. No.: 12/762,737

(22) Filed: Apr. 19, 2010

(51) Int. Cl. G06Q 30/00

(52) U.S. Cl. 705/14.58

(57) ABSTRACT

Methods and systems for determining advertisement relevance based on time and spatial relationships or reachable locations may include determining a set of advertisements, a set of destination locations corresponding to the advertisements, a starting location, a starting time, and a desired arrival time. A particular destination location may be identified as reachable if a projected arrival time occurs prior to or at the desired arrival time. Reachable destination locations may be distinguished from unreachable destination locations on a user interface by at least one of presenting reachability indicators, differentiating presentations or appearances of indications corresponding to reachable locations and/or of corresponding advertisements, ordering location indications and/or advertisements by reachability relevance, omitting unreachable destination locations and/or corresponding advertisements from being presented on the user interface, or other actions. Advertisement relevance based on time and spatial relationships may be based on user input, and may be applied to multiple, sequential destination locations.

### BACKGROUND

This Background is intended to provide the basic context of this patent application and it is not intended to describe a specific problem to be solved. Advertisements displayed in a computing environment are typically based on context that is related to direct user input or is inferred from user actions or other data. Advertisement relevance does not typically account for time and spatial relationships between a user location and an advertiser's location. If the user is not able to arrive at a particular advertiser's location before the location closes, the advertisement corresponding to the particular advertiser's location is not as relevant as another advertisement corresponding to a different advertiser whose location is reachable before closing time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of a method for determining advertisement relevance based on reachable locations are disclosed. The method may include determining a set of advertisements, a set of destination locations corresponding to the set of advertisements, a starting location, a starting time and a desired arrival time. The method may include determining that a particular destination location is reachable if the projected arrival time at the particular destination location occurs before or equivalent to the desired arrival time. The method may include distinguishing reachable destinations from unreachable destinations on a user interface.

Embodiments of a computing device for determining advertisement relevance based on reachable locations are disclosed. The computing device may include a memory, a processor, a user interface, a connection to a display, and computer-executable instructions for determining a set of advertisements based on a term (e.g., a user input or an inferred term), a set of destination locations corresponding to the set of advertisements, a starting location, a starting time and a desired arrival time. The method may include determining that a particular destination locations is reachable if the projected arrival time at the particular destination location occurs prior to or at the desired arrival time, and distinguishing reachable destination locations on a user interface by distinguishing an indication of the particular destination location and/or distinguishing a corresponding advertisement.

Embodiments of a display are disclosed, where the display includes a set of advertisements and an indication that a particular advertisement corresponds to a destination location that is reachable prior to or at a desired arrival time. The display may distinguish reachable destination locations from unreachable destination locations by using a reachability indicator, a presentation differentiation of location indicators and/or of advertisements, an order of presentation of location indicators and/or of advertisements, an omission of unreachable destination locations, and/or other distinguishing actions employed on a textual display, a map display, and/or other user interface.

### DRAWINGS

FIG. 1 is an illustration of a computing system environment;

FIG. 2 is an embodiment of a method for determining advertisement relevance based on reachable locations;

FIG. 3A illustrates a display of advertisements relevant to reachable locations, including a textual and a map portion;

FIG. 3B is an embodiment of the textual portion of FIG. 3A; and

FIG. 3C is an embodiment of the textual portion of FIG. 3A.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

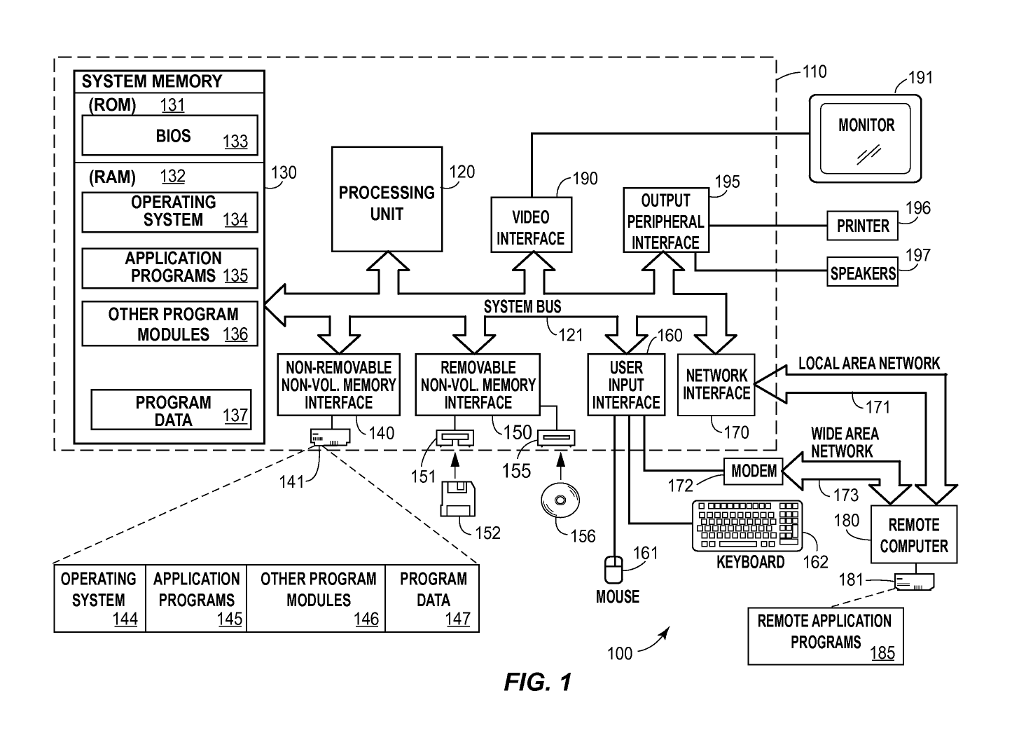

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141, a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include one or more other networks such as client/server, peer-to-peer, cloud computing, and others. Networks may be wireless, wired, or a combination of the two. Such networking environments are commonplace in offices, enterprise-wide computer networks, intranets, and the Internet.

Computing device 110 may encompass many different computing device configurations. For example, computing device 110 may realized in hand-held devices, mobile phones, smart communication devices, multi-processor systems, microprocessor-based or programmable consumer electronics, network PCs, minicomputers, mainframe computers, portable computing or communication devices, and or other computing device capable of both visual display and direct or indirect communication with another computing device.

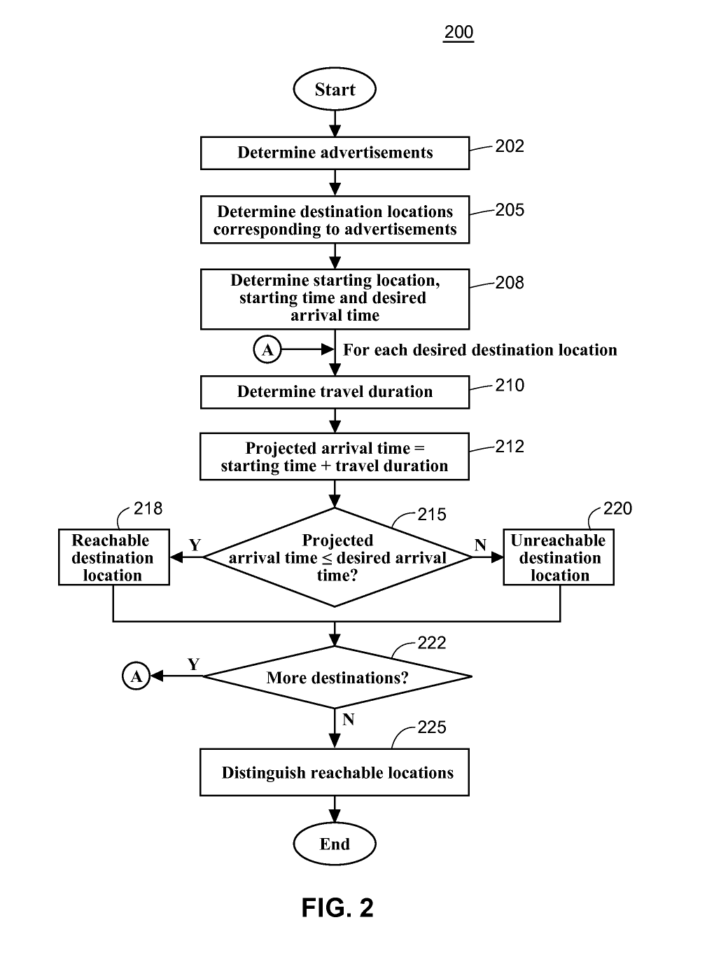

FIG. 2 is an embodiment of a method 200 for determining advertisement relevance based on reachable locations. FIG. 2 may operate in conjunction with embodiments of the computing device 110 and the computing system 100 of FIG. 1. For example and not by limitation, some or all of computer-executable instructions for performing the method 200 may be stored on the memory 130 of the computing device 110, and/or some or all of the method 200 may be performed by the processing unit 120 of the computing device 110.

The method 200 includes determining a set of advertisements 202. Determining the set of advertisements 202 may be based on a user input, a user action, a user characteristic, and/or from other contexts. For example, a user may enter a search or query term such as “Running shoes,” and a set of advertisements corresponding to “Running shoes” may be determined 202. The set of advertisements may include advertisements for running shoes and in some cases, apparel, accessories and other running-related products. In another example, a user may visit a running website, or the user may click on a “running” button in response to an activities survey, and the set of advertisements may be derived from one or both of these user actions. In yet another example, the set of advertisements may be determined from a user characteristic, such as a from a user profile including an indication of a “female” gender and a favorite activity of “triathlons.” For this example, the corresponding set of advertisements may be determined based on the user profile, and may include advertisements for women's running shoes, women's apparel, cycling equipment, swimming accessories, upcoming triathlon events, etc. Of course, the set of advertisements may be determined 202 based additionally or alternatively on other user-related information.

An “advertisement,” as used herein, may include a direct or indirect reference to a product or service that is for sale. The “advertisement” may include a representation of the product or service that is for sale (e.g., textual name, textual description, pictorial image, etc.) The textual name and description may range from general to specific, for example, “ACME running shoes—all sizes, all brands available,” or “Special on ACME model 102 in stock.”) Each advertisement may include a name of a destination, an address of the destination location, and other reference or identifying information such as a phone number or a link to a website, however, not every advertisement is required to include the same set of identifying or reference information or include all types of reference information. Indeed, “advertisements” need not be limited to products or services that are for sale, or limited to products or services in general. An advertisement may correspond to a destination location such as a museum, a zoo, a school, a religious institution, a hospital or clinic, a post office, a recreation center, a library or any other destination.

At block 205, destination locations corresponding to the set of advertisements may be determined. A single destination location may correspond to a single advertisement, or in some cases, multiple destinations may correspond to a single advertisement, such as when several chain store locations carry the same product. Destination locations corresponding to advertisements 205 may be determined from locally or remotely stored data.

At block 208, a starting location, a starting time and a desired arrival time may be determined. The starting location may be determined based on explicit or implied user input. Additionally or alternatively, the starting location may be determined by using available location technology, such by using a GPS location of a device whose processor is executing the block 208, or by deriving the starting location from IP addresses, cell towers or other information from the device itself or from communication systems with which the device is in communication. Similarly, the starting time may be determined based on explicit or implied user input, and additionally or alternatively, the starting time may be determined based on a system clock, such as a system clock of a computing device executing the block 208 or a system clock of a system with which the computing device is in communication. In some embodiments, a present system clock time may be the default starting time.

The desired arrival time may be determined based on explicit or implied user input. For example, the desired arrival time may be determined by direct user input (e.g., “5:30 p.m.,” “between 5:00 and 5:30 p.m. on Tuesday,” etc.) Alternatively, the desired arrival time may be derived based on an event or an appointment recorded in a user's electronic calendar or in a different calendar, gleaned from a website, embedded in an email message, or some other source. In some scenarios, (and typically as a default desired arrival time), the desired arrival time may be based on a closing time of a destination location, so that the user is able to arrive at the destination location before it closes. The closing time may be determined from locally or remotely stored data, such as stored business hours or hours of operation.

At blocks 210-222, the destination locations may be evaluated to determine if they are reachable. In some cases, each of the destination locations from block 205 may be evaluated, and in other cases, only a subset of the destination locations from the block 205 may be determined to be evaluated. Various criteria may be used to determine the subset of destination locations. In one embodiment, the subset of destination locations may be determined based on a desired distance from the starting location, where the desired distance corresponds to a user preference, a type of product or destination, a size of a map display, or some other criteria. Accordingly, only the subset of destination locations located within the desired distance from the starting location may be evaluated. The desired distance may be indicated by a user, or may be automatically determined. For example and not by limitation, the method 200 may assign a further desired distance to visit a museum or to shop for a sofa and a lesser desired distance to shop for a gallon of milk or for a light bulb. In another example and not by limitation, the subset of destination locations may change accordingly as a map illustrating possible destination locations is enlarged or shrunk. In yet another non-limiting example, a user may specify a desire to travel less than two miles.

In another embodiment, the subset of destination locations may be determined based on a desired travel duration, so that only destinations able to be reached within the desired travel duration are evaluated. Desired travel durations may be (similar to desired distances) based on a user preference, a type of product or destination, or on some other criteria. For example and not by limitation, a user may be willing to travel an hour to visit an amusement park but only fifteen minutes to borrow a library book. In another example, the method 200 may automatically set desired travel durations for rural areas to be greater than those in urban areas. Generally, any automatically set limits (whether based on a desired distance, a desired duration of travel, or other criteria for identifying a subset of destination locations) may be set corresponding to a category of commerce, a retail density, a population density, or some other criteria. A user may override any or all automatically set limits.

In some situations, if hours of operation or business hours of certain destination locations are not readily available, the method 200 may omit these certain destination locations from being evaluated. In some embodiments, a user may specify to the method 200 whether or not such destination locations are to be omitted. In some embodiments, the user may specify whether some destination locations are to be omitted based on other criteria (e.g., omit destinations for which I do not have a frequent buyer's card, omit destinations that are unreachable via public transportation, etc.).

At the block 210, for each of the destination locations (either in the entire set or subset of destination locations, if so limited), a travel duration from the starting location to the destination location may be determined, estimated, or projected. The travel duration may be determined 210 using any known or future method of determining travel durations, such as those based on traffic conditions, speed limits, weather, mode of transportation, time of day when the travel is to occur, and the like. Of course, one of ordinary skill will recognize that in embodiments where the subset of destination locations is desired to limited by travel duration, the block 210 may be executed on each of the destination locations determined at the block 205 so that corresponding projected travel durations may be determined, but the remaining blocks 212-222 of the evaluation may be performed only on the subset with projected travel durations less than the desired travel duration.

At the block 212, a projected arrival time at the destination location is determined. In some embodiments, the projected arrival time may be determined by adding the projected travel duration to the starting time.

If, as determined at the block 215, the projected arrival time occurs prior to or at the desired arrival time, the destination location may be determined to be reachable 218 and may be so flagged or stored. Conversely, if the projected arrival time is determined to occur after the desired arrival time, then the destination location may be determined to be unreachable 220 and may be so flagged or stored. The method 200 may return to block 210 to evaluate additional destination locations 210-220 until block 222 determines that the method 200 has evaluated all destination locations of the desired entire set or subset of destination locations, if so limited.

At block 225, reachable destination locations are distinguished from unreachable destination locations. In some embodiments, the reachable destinations may be distinguished by sending a list or other representation of only the reachable destinations to another computing device or entity or by writing them to a file or to other data storage. In other embodiments, all destinations may be sent or written, but only the reachable destinations may be distinguished by an indicator that signifies reachability, such as a symbol, a label, or a difference in appearance.

In a preferred embodiment of the block 225, the reachable destinations may be distinguished on a visual display, an audio output, or other user interface. For example, a reachability indicator signifying that a destination is reachable may be included on the user interface, where the reachability indicator is presented in conjunction with an indication of the destination and/or in conjunction with an advertisement corresponding to the destination. The reachability indicator may be an icon, a flag, a symbol, a label, and/or some other indicator. In some examples, at least a portion of the indication of the destination of the corresponding advertisement may be differentiated to indicate reachability (e.g., a different font or text treatment, a different color, a different audio sound or tag, highlighting some portion, flashing, etc.). In some examples, advertisements whose corresponding destination locations are reachable may be presented on the user interface before advertisements corresponding to unreachable destination locations are presented. In some examples, advertisements corresponding to unreachable destinations may be omitted from the display altogether. One or more of these distinguishing actions or other distinguishing actions may be used to distinguish reachable destination locations 225.

In some embodiments, in additional to signifying reachability/unreachability relevance, an output on the user interface may reflect one or more other detailed relevance ranking criteria. For example, a user interface may list, rank or present reachable destination locations ordered by soonest projected arrival time. In another example, the user interface may list, rank or present reachable destination locations ordered by shortest projected duration of travel. Other relevance ranking criteria may also be possible.

In some embodiments, the set of distinguishing actions and/or the number, types and/or order of relevance ranking criteria used by the method 200 may be based on user preference or input. Generally, any of the various possible user inputs discussed herein (e.g., starting location, starting time, desired arrival time, criteria for determining a subset of destination locations, preference of distinguishing actions, relevance ranking criteria, whether or not unreachable destinations should be displayed, additional user criteria or preferences for defining a destination as unreachable, and others) may be obtained via a single user input or via multiple user inputs. In some embodiments, a user may create a stored profile that is accessible by the method 200 and indicates some or all of his or her preferences.

In some scenarios, no destinations in the destination locations (or subset of destination locations, if so determined) may be evaluated by the method 200 to be reachable. In these scenarios, the method 200 may indicate that no destinations are reachable, such as via a text string indication, a visual or audio indication, or by some other indication.

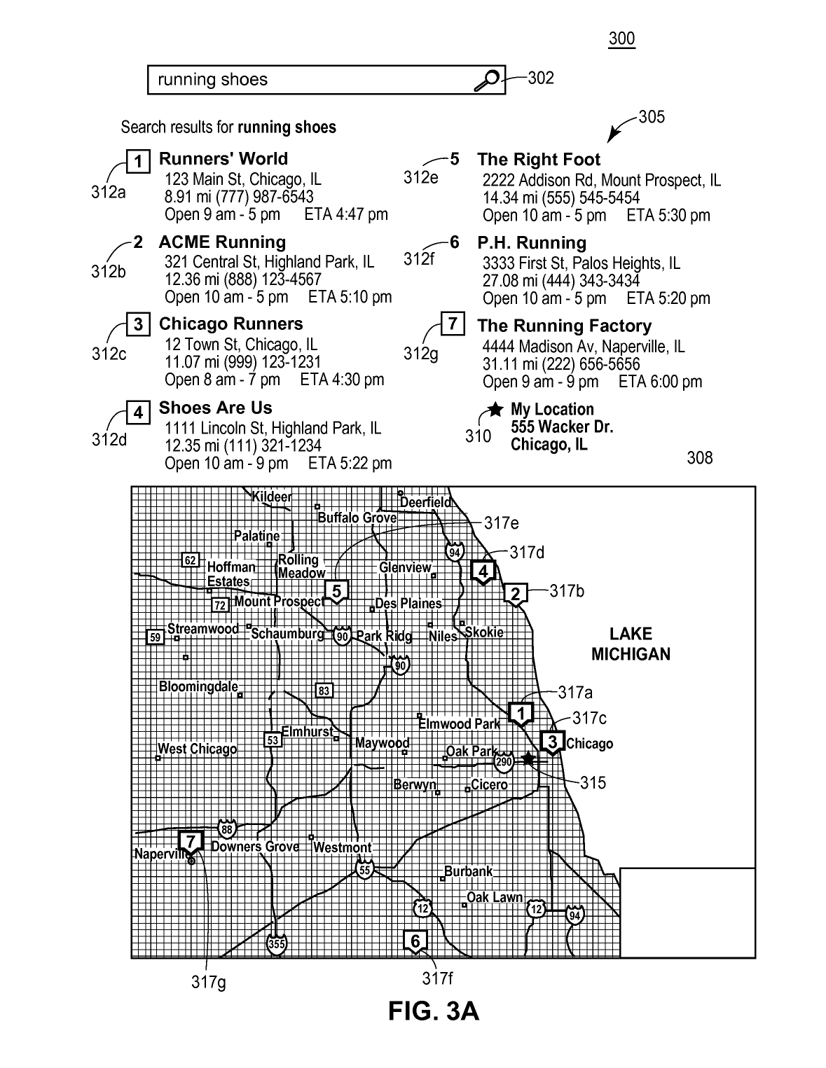

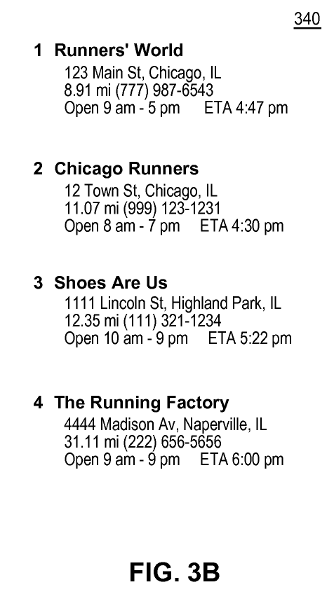

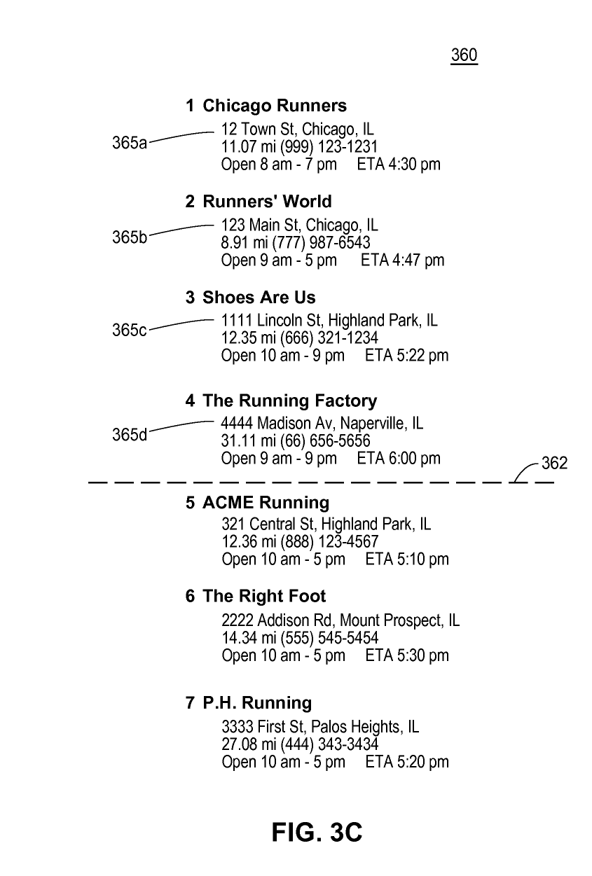

FIG. 3A is one illustrative (but not limiting) example of a display 300 where reachable destination locations are distinguished from unreachable destination locations. The display 300 may operate in conjunction with the computing device 110 and computing environment 100 of FIG. 1, and the method 200 of FIG. 2.

The display 300 is illustrated as including three components: a user input portion 302, a textual portion 305 and a map portion 308, however, in some embodiments, only the textual portion 305 may be included or only the map 308 portion may be included. In some embodiments, the user input portion 302 may be omitted, such as when the user input occurs on a previous screen.

In the display 300, though, the user input portion 302 is included, and a user has entered the text string “running shoes” as a search term. The display 300 illustrates the advertising results of the search in both the textual 305 and the map 308 portions. The textual portion 305 includes a starting location indication 310 including an identifier (e.g., “My Location”) and an address (e.g., “555 E. Wacker Dr., Chicago, Ill.”). The textual portion 305 of the display includes set of advertisements 312a-312g, each of which includes a store or vendor name and an address. Each textual advertisement 312a-312g shown in FIG. 3A also includes the distance of the destination location from the starting location, hours of operation or other similar indication, and an estimated time of arrival from the starting location. In some embodiments, one or more textual destination locations 312a-312g may include a link to a website corresponding to the store or to the location (not shown). Additionally, one of skill in the art will appreciate that although indications 312a-312g are depicted as textual, in some embodiments, an advertisement may also include a graphic such as a picture of the storefront or the product. Generally, a “textual advertisement” or “textual information,” as used herein, may include any representation of destination location information with the exception of a mapped representation. Also note that as the display 300 of FIG. 3A is exemplary, in other embodiments, some of the information displayed in the textual portion 305 may be omitted. For example, in other embodiments, parts or all of the starting location indication 310, a distance of the destination from the starting location, hours of operation, an estimated time of arrival, or other information may be omitted.

The map portion 308 of the display includes an indicator 315 corresponding to the starting location and respective indicators 317a-317g corresponding to each of the locations 312a-312g listed in the textual portion 305. The indicators 317a-317g are each positioned on the map according to their respective address. In some embodiments, when the user mouses over or clicks on an indicator 317a-317g, a pop-up window or similar may appear that may present some or all of the corresponding textual information 312a-312g for the location.

The reachable destination locations 312a/317a, 312c/317c, 312d/317d, and 312g/317g are distinguished on the display 300 from the unreachable destination locations 312b/317b and 312f/317f. In the embodiment illustrated in FIG. 3A, the textual reachable destination location indications 312a, 312c, 312d and 312g are distinguished by a box around a corresponding identifying numeral. Other distinguishing actions are also possible, such as (but not limited to) changing a portion or all of an appearance of the reachable textual descriptions (e.g., italicizing, bolding, highlighting, changing a color, changing a font size or type, flashing, etc.), adding an icon or other indicator corresponding to one or more reachable destination location, listing reachable destination locations together in a separate portion of the screen, and the like. In some embodiments, more than one distinguishing action may be applied to textual reachable destination location indications 312a, 312c, 312d and 312g.

The mapped reachable destination locations 317a, 317c, 317d and 317g are distinguished on the display 300 from the unreachable destination locations 317b, 317f by a different colored border. Other distinguishing actions are also possible, such as (but not limited to) changing a portion or all of an appearance of the mapped reachable destination location indications such as by italicizing, bolding, highlighting, changing a font type, flashing, etc. In some embodiments, more than one distinguishing action may be applied to mapped reachable destination location indications 317a, 317c, 317d and 317g.

In some embodiments, the textual reachable destination location indications 312a, 312c, 312d and 312g and/or the mapped reachable destination location indications 312a, 312c, 312d and 312g may be distinguished by being the only displayed destination location indications. That is, unreachable destination locations, whether textual 312b, 31bf or mapped 317b, 317f may be omitted from the display 300 altogether. One example of such an embodiment 340 of the textual portion 305 where unreachable destinations are omitted from display is shown in FIG. 3B.

FIG. 3C shows a different embodiment 360 of the textual portion 305 of FIG. 3A. Here, the textual reachable destinations are sorted or ranked by additional relevance criteria. First, the destination locations are segmented by whether or not they are reachable, as indicated by the dashed line 362. Reachable destinations are presented above the line 362, and unreachable destinations are presented below the line 362. (Of course, while the embodiment 360 uses the dashed line 362 to distinguish reachable locations from unreachable locations, other distinguishing actions including at least those previously discussed may be alternatively or additionally used.) Next, the reachable destination locations 365a-365d are ranked (e.g., sorted or presented) in relevance by estimated time of arrival from soonest to latest.

Relevance ranking criteria of the advertisements and the resulting presentation of advertisements and/or destination locations are not limited to the embodiments shown in FIGS. 3A-3C. Other embodiments may also be used in conjunction with the present disclosure. For instance, results may be sorted and or distinguished based on user input. In some embodiments, several priorities or passes of ranking criteria may be used. For example and not by limitation, a first relevance ranking may be performed based on a difference between estimated arrival time and desired arrival time, and a second, subsequent relevance ranking may be performed based on least duration of travel. The number, types and order of sorting passes for relevance ranking may be configurable and may be user-selectable.

The methods, systems and displays of the present disclosure (and in particular, those described with respect to FIGS. 1, 2, and 3A-3C) are easily adaptable to a sequential set of destination locations (as used herein, “multi-destination relevance”), such as (and not by limitation) when a user has items on his or her errand list that may be serviced by two or more different destination locations. Consider the scenario of a user wishing to buy running shoes and a gallon of milk in light of the method 200 of FIG. 2. At the block 202, the method 200 may determine a set of advertisements corresponding to the running shoes and a set of advertisements corresponding to the milk. Typically, but not necessarily, for a multi-destination relevance determination, the set of advertisements may be determined 202 based on user input, e.g., “running shoes” and “milk.” At the block 205, destination locations corresponding to “running shoes” and destination locations corresponding to “milk” may be determined, and at the block 208, the starting location, starting time and desired arrival time may be determined using techniques similar to those previously discussed. Different desired arrival times may be determined for each different destination location—for example, if different destination locations have different closing times—and an overall end desired arrival time for the entire multi-destination route may be determined.

Note that for some cases, even though a user may input multiple search terms, a single destination location may be able to service all requests, e.g., a superstore that sells both running shoes and milk. The single destination may be determined to be a possible destination location along with possible combinations of ordered, multiple destinations (e.g., running shoe store #1 plus grocery store #1, convenience store #3 and sports equipment store #4, etc.) The remainder of the discussion, however, will be focused on multiple destinations, as a single destination location option in a multi-destination scenario may be evaluated by the method 200 as previously discussed.

The blocks 210-222 may accommodate multiple possible destination locations. To continue the “running shoe” and “milk” example, determining the travel duration 210 may include determining a sequential travel duration from the starting location to a first destination, and then subsequently from the first destination location to a second destination location. It follows that determining the projected overall end arrival time 212 may include adding the sequential travel duration to the start time.

At block 215, for multi-destination relevance, a sequential combination of destinations may be determined to be reachable 218 if the first destination is reachable prior to its desired arrival time (be it a closing time, a user-specified time, or other), and the second, subsequent destination is reachable prior to the overall end desired arrival time. Note that for multi-destination relevance, each ordered combination of the multiple destinations may need to be evaluated by the blocks 210-222, as the order of travel through the different destinations may affect reachability. At the block 222, for multi-destination relevance, reachable combinations of destinations may be distinguished, and their respective order of travel (e.g., which destination to travel to first, second, and so on) may be presented.

Although only two destinations were discussed above, the method 200 may easily be extended to support more than two destination locations. In some embodiments, the method 200 may determine the multiple destinations or an ordering thereof based on user input. For example, a user may specify a desired order of travel (e.g., send me to a store to pick up “running shoes” before “milk” so the milk doesn't spoil), the user may specify criteria such as “minimize overall travel duration,” “minimize total distance traveled,” or the user may specify some other criteria.

In conclusion, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method for determining advertisement relevance based on reachable locations, including:
determining a set of advertisements, and determining a set of destination locations corresponding to the set of advertisements;
determining a starting location, a starting time and a desired arrival time;
determining if each destination location of at least a subset of the destination locations is reachable, including:
determining a travel duration from the starting location to the each destination location;
determining a projected arrival time, including adding the travel duration to the starting time; and
identifying the each destination location as reachable if the projected arrival time is before or equivalent to the desired arrival time; and
distinguishing reachable destination locations on a user interface.

2. The method of claim 1, wherein determining the set of advertisements comprises determining the set of advertisements based on a term corresponding to at least one of a user input, a user action or a user characteristic.

3. The method of claim 1, wherein distinguishing the reachable destination locations comprises performing at least one of a set of distinguishing actions comprising:
including, on the user interface, a reachability indicator corresponding to at least one of a particular reachable destination location or a particular advertisement corresponding to the particular reachable destination location;
differentiating at least a portion of at least one of an indication of the particular reachable destination location or the particular advertisement;
presenting, on the user interface, the particular advertisement before presenting another advertisement corresponding to an unreachable destination location; or
omitting, from the user interface, indications of unreachable destination locations and advertisements corresponding to the unreachable destination locations.

4. The method of claim 3, further comprising receiving an indication of a user preference of one or more of the set of distinguishing actions.

5. The method of claim 1, further comprising indicating, on the user interface, that no destination location in the at least the subset of the destination locations is reachable when no destination location in the at least the subset of the destination locations is identified as being reachable.

6. The method of claim 1, wherein determining the starting location, the starting time, and the desired arrival time comprises determining at least one of the starting location, the starting time, or the desired arrival time based on user input.

7. The method of claim 1, wherein determining the desired arrival time comprises determining the desired arrival time based on an event, an appointment, or a closing time of the each destination location of the at least the subset of the destination locations.

8. The method of claim 1, further comprising further distinguishing the reachable destination locations based on lengths of corresponding travel durations.

9. The method of claim 1, further comprising determining the at least the subset of the destination locations based on at least one of a desired distance from the starting location or a desired travel duration.

10. The method of claim 1, wherein:
determining if the each destination location of the at least the subset of the set of destination locations is reachable comprises determining if a first and a second desired destination location are sequentially reachable;
determining the travel duration from the starting location to the each destination location comprises determining a sequential travel duration from the starting location to one of the first or the second desired destination location and subsequently from the one of the first or the second desired destination location to the other one of the first or the second desired destination location;
adding the travel duration to the starting time comprises adding the sequential travel duration to the starting time;
identifying the each destination location as reachable comprises identifying the first and the second desired destination locations as sequentially reachable; and
distinguishing the reachable destination locations comprises distinguishing indications and advertisements corresponding to one or both of the first and the second desired destination locations.

11. A computing device for determining advertisement relevance based on reachable locations, comprising:
a memory, a processor, a user interface, a connection to a display, and
computer-executable instructions stored on the memory and executable by the processor, the computer-executable instructions for:
determining a set of advertisements based on a term based on a user input received via the user interface, and determining destination locations corresponding to the set of advertisements;
determining a starting location, a starting time and a desired arrival time;
determining if each destination location of at least a subset of the destination locations is reachable, including:
determining a travel duration from the starting location to the each destination location;
determining a projected arrival time, including adding the travel duration to the starting time; and
identifying the each destination location as reachable if the projected arrival time is before or equivalent to the desired arrival time;
distinguishing, on the display, reachable destination locations comprising distinguishing at least one of: an indication corresponding to a particular reachable destination location, or a particular advertisement corresponding to the particular reachable destination location; and
indicating, on the display, that no destination location in the at least the subset of the destination locations is reachable when no destination location in the at least the subset of the destination locations is identified as being reachable.

12. The computing device of claim 11, wherein distinguishing the reachable destination locations comprises selecting at least one from a set of distinguishing actions comprising:
displaying a reachability indicator corresponding to at least one of the particular reachable destination location or the particular advertisement corresponding to the particular reachable destination location;
differentiating at least a portion of at least one of the indication of the particular reachable destination location or the particular advertisement;
displaying the particular advertisement before an advertisement corresponding to an unreachable destination location; or
omitting, from the display, indications of unreachable destination locations and advertisements corresponding to the unreachable destination locations.

13. The computing device of claim 11, wherein at least one of determining at least one of the starting location, the starting time, or the desired arrival time or distinguishing the reachable destination locations is based on the user input or based on another user input.

14. The computing device of claim 11, wherein determining the desired arrival time comprises at least one of determining the desired arrival time based on an event or an appointment or determining a closing time of the each destination location of the at least the subset of the destination locations.

15. The computing device of claim 11, wherein:
determining if the each destination location of the at least the subset of the destination locations is reachable comprises determining if a first and a second desired destination location are sequentially reachable;
determining the travel duration from the starting location to the each destination location comprises determining a sequential travel duration from the starting location to one of the first or the second desired destination location and subsequently from the one of the first or the second desired destination location to the other one of the first or the second desired destination location;
adding the travel duration to the starting time comprises adding the sequential travel duration to the starting time;
identifying the each destination location as reachable comprises identifying the first and the second desired destination locations as sequentially reachable; and
distinguishing the reachable destination locations comprises distinguishing at least one of: indications of the first and the second desired destination locations, or advertisements corresponding to the first and the second desired destination locations.

16. A display, comprising:
a set of advertisements; and one of:
an indication that a particular advertisement corresponds to a particular destination location that is reachable prior to or at a desired arrival time comprising at least one of:
a reachability indicator corresponding to at least one of the particular advertisement or an indication of the particular reachable destination location;
an appearance differentiation of at least a portion of at least one of the particular advertisement or the indication of the particular reachable destination location; or
an order of appearance of the particular advertisement and an advertisement corresponding to an unreachable destination location; or
an indication that no advertisements in the set of advertisements corresponds to any destination location that is reachable prior to or at the desired arrival time.

17. The display of claim 16, further comprising a set of destination location indications, each destination location indication corresponding to a different advertisement, and wherein reachable destination locations are distinguished from unreachable destination locations.

18. The display of claim 17, wherein at least one of a particular destination location indication corresponding to the particular reachable destination or the particular advertisement includes an address of the particular reachable destination location and at least one of an indication of a time that the particular reachable destination location is open or a projected arrival time.

19. The display of claim 16, wherein the particular destination location is identified as reachable when a projected arrival time is at or earlier than the desired arrival time, the projected arrival time comprising a travel duration, from a starting location to the particular destination location, added to a starting time.

20. The display of claim 16, wherein the set of advertisements is limited based on a desired distance from a starting location or a desired travel duration from the starting location.
